(19) United States
(12) Patent Application Publication
(10) Pub. No.: US 2013/0118969 A1
(43) Pub. Date: May 16, 2013

(54) Food waste disposal system including BOD reduction apparatus

(71) Applicant: Chun Il Koh, Seoul (KR)

(72) Inventor: Chun Il Koh, Seoul (KR)

(21) Appl. No.: 13/337,039

(22) Filed: Dec. 23, 2011

(30) Foreign Application Priority Data
Nov. 16, 2011 (KR) 10-2011-0119269

(51) Int. Cl. B01D 36/00

(52) U.S. Cl. 210/295

(57) ABSTRACT

The present invention provides a food waste disposal system including a BOD reduction apparatus comprising a concentrated-oxidizing tank, an aeration tank, an air pump and a filter. A drain of food waste disposal system is connected to a inlet of the BOD reduction system. Also, purified water in the BOD reduction system is carried back to a inlet of said food waste disposal system so that purified water is reused in food waste disposal system. A pH sensor, which can measure acidity and basicity, is mounted on a filter drain of the BOD reduction system. When pH of the sensor is less than pH 3, small quantity of caustic soda powder is input from a caustic soda tank mounted on the pipe of the rear end of a water supplying valve of the food waste disposal system to regulate the pH level of food wastewater.

### BACKGROUND OF THE INVENTION

1. Field of the Invention

The present invention relates to a food waste disposal system comprising a BOD reduction apparatus installed at the drain of the food waste disposal system so that food wastewater coming from the food waste disposal system to be purified and recycled, meeting the sewage quality requirement of each country.

2. Description of the Prior Art

Generally, organic waste, such as food waste, contains a large amount of fibrous vegetable and animal material, protein, carbohydrates and calcium. Accordingly, if the organic waste is disposed of as it is in a landfill, without being decomposed, leachate generated from the organic waste permeates into the soil, resulting in the contamination of ground water.

Conventional food waste disposal technologies using microbes are disclosed in Korea Utility Model Publication Nos. 20-1995-5245, 20-1995-7541, 20-1995-7395, Korean Patent Laid-Open Publication Nos. 20-1994-24804. These technologies are related to methods and apparatuses of fertilizing and composting food waste or organic waste.

The conventional methods and apparatuses can reduce some of the organic matter in food waste or organic waste, but are insufficient with respect to disposal efficiency and capacity because they take a long period to decompose organic matter and they cannot completely decompose organic matter. As a result, odors are generated due to the hazardous gas generated upon the incomplete decomposition of food waste.

Korean Utility Model No. 20-270982 discloses “Apparatus for Decomposing Organic Waste”, Korean Patent Laid-Open Publication No. 10-2006-19663 discloses “Apparatus for Treating Food Waste”, and Korean Patent No. 10-535699 discloses “Structure of Mixing Basin of Apparatus for Treating Food Waste”.

Korean Utility Model Registration No. 20-20982 discloses “Apparatus for Decomposing Organic Waste”, which comprises a rotational shaft having a plurality of arm blades, installed along a central horizontal line of a cell casing provided in a housing, a rotation device which includes a gear motor, a driving sprocket, a linking sprocket, and a chain, for rotating the rotational shaft, a hot water tank, and a sprayer with a plurality of spray nozzles, which is installed in an upper part of the cell casing for spraying hot water from the hot water tank into the cell casing, in which the inner temperature of the cell casing can be adjusted by selectively supplying the hot water from the hot water tank, which is provided with a pre-heater.

Korean Patent Laid-Open Publication No. 10-2006-19663 discloses “Apparatus for Treating Food Waste”, in which food wasted introduced through an entrance formed in an upper portion of a treatment basin is pulverized when it passes through a pulverizing mill and falls down, the pulverized food waste is mixed by mixing blades and decomposed, and then the decomposed food waste is discharged, in which the treatment basin is cleaned by spraying water using a sprayer installed in an upper portion of the treatment basin.

Korean Patent No. 10-535699 discloses “Structure of Mixing Basin of Apparatus for Treating Food Waste” which comprises an outer casing having mixing blades therein, an upper plate which has a drain with a screen thereon and is fixed to the lower end portion of the outer casing, and a lower plate having a drain in the center portion thereof, which is provided under the upper plate and is integrated with the upper plate, in which food waste introduced through an entrance of the outer casing and onto the upper plate is mixed by the mixing blades, and leachate from the food waste is drained through the screen, flows down to the lover plate, and is then discharged through the drain provided to the lower plate.

The above-described food waste disposal apparatuses are operated using manual switches in an analog manner. Accordingly, they have problems in that the manipulation thereof is inconvenient and in that they cannot be selectively operated in either an automatic manner or a manual manner. Further, since hot water cannot be supplied into the mixing basin, the food waste treatment capacity and efficiency thereof are low, and it is difficult to clean the inside of the cell casing, and thus odors linger around the apparatus. Further, since a cleansing device for cleansing the lower plate, on which leachate collects, is not provided, odors occur. Still further, since the mixing basin does not have a leachate discharge device, leachate overflowing from the cell casing cannot be easily discharged, so that the apparatus cannot be smoothly operated.

In order to overcome the disadvantage of problems above, U.S. Pat. No. 7,735,761 and U.S. Pat. No. 7,762,713 to the inventor discloses a food waste disposal system by putting microbes during a process of drying the food waste, comprising a mixing basin installed in a housing, and a rotational shaft with a plurality of mixing blades.

Although the food waste disposal system of U.S. Pat. No. 7,735,761 and U.S. Pat. No. 7,762,713 have resolved the prior art's drawbacks, in the process that the leachate produced by the microbe's biological decomposition goes to drain or sewer system with cleansing water, it is hard to maintain the quality of waste water so as to satisfy the environmental regulation proposed by the countries and in the worst case, the food waste disposal system is banned to use in some countries. To overcome this issue, there needs an additional device attached to the food waste disposal system, which improves the waste water quality to meet the each countries' environmental requirement.

Also, there is a large amount of water required to discharge the decomposed food waste to the drain. Normally, to maintain the supportive environment inside the mixing basin for effective decomposition process of food waste, water supply function which provides the moisture inside the mixing basin, and discharge function which provides the cleansing the washing chamber, these two functions are operated in every cycle at the operation of the food waste disposal system. The usage of water for two functions consumes 4 liter per cycle, and when summed up to daily usage, water required per day goes up to 400 liters. The fact that the substantial amount of water usage discourages the user to operate the food waste disposal system environmentally friendly, thus the more effective water usage system that uses less water should be considered.

### SUMMARY OF THE INVENTION

Therefore, the present invention has been made in view of the above problems with an object to provide an improved food waste disposal system with the BOD reduction system, comprising of a concentrated-oxidizing tank, an aeration tank, a filter and an air pump. Influent food wastewater which contains food residuals discharged from the food waste disposal system enters the concentrated-oxidizing tank through an inflow pipe and is stored in the tank for several days. Subsequently, in the tank, the food wastewater is mixed with air supplied from an air pump and oxidized by aerobic bacteria. The influent food wastewater discharged from the concentrated-oxidizing tank is mixed with activated sludge in the aeration tank which facilitates the absorption and oxidative decomposition of organic matter by supplying oxygen via the air pump. The influent food wastewater purified in the aeration tank is filtered through different layers of sand, gravel, granule gravel, charcoal and glass wool. The air pump works to supply air to the concentrated-oxidizing tank and the aeration tank.

The food wastewater discharged from the food waste disposal system flows into the BOD reduction system, and pipe connections are made so that the water purified in the BOD reduction system flows back into the food waste disposal system.

According to an embodiment of the present invention, the oxidizing aeration tank comprises two chambers—the first aeration chamber and the second aeration chamber. The first aeration chamber receives influent food wastewater from the concentrated-oxidizing tank through a connecting pipe. It is equipped with a fixed media and a disc rubber diffuser which allows aeration to occur when oxygen flows into the tank by blowing air in through an air pipe from the outer air pump. The second aeration chamber is equipped with a plate-type media and a membrane diffuser which allows aeration to occur when oxygen flows into the tank by blowing air in through an air pipe from the outer air pump.

According to an embodiment of the present invention, the BOD reduction system has the concentrated-oxidizing tank in front and the oxidizing aeration tank in back and provides space where a filter will be installed on the right side of the oxidizing tank, the width (W1) of which is to be one half of the aeration tank's width (W0). The filter is set up in the space on the right of the oxidizing tank, and the total width of the filter area is not to be greater than the aeration tank's width (W0). The air pump is placed between the oxidizing tank and the aeration tank and thus the BOD reduction system features an overall square-shaped arrangement with side length equal to the oxidizing tank's width (W0).

According to an embodiment of the present invention, the BOD reduction system's concentrated-oxidizing tank, aeration tank and filter are connected to each other by connecting pipes, and the connecting pipes remain adjusted to specific heights so that the next process can automatically start when the influent food wastewater reaches a certain level (H1 or H2).

According to an embodiment of the present invention, the filter has high and low water level sensors on its upper and lower parts and the low water-level sensor serves to detect the volume of purified water so that water volume is maintained at more than a certain level. The water purified by the filter is sent back to the food waste disposal system, supply recycled water to the water supplying cycle.

According to an embodiment of the present invention, the food waste disposal system comprises a water supplying valve which opens and closes the water supply from waterworks; a water supplying pump which pumps water supplied from the water supplying valve into the mixing basin; a discharge valve which is opened or closed by the Programmable Logic Controller (PLC) for water supplied from waterworks to be drawn into the washing chamber's discharging water supply nozzle; a caustic soda tank valve which opens and closes the feed for caustic soda stored in the caustic soda tank; a reusable water supplying valve which is opened or closed by the PLC for supply of water purified in the BOD reduction system's filter; high and low water level sensors which work to detect the water levels of the BOD reduction system's filter; a pH sensor set up in the filter drain to measure acidity and basicity; a final drain valve set up in a final drain; and the PLC which firstly controls the caustic soda tank valve allowing caustic soda to be put in water pumped by the water supplying pump based on a pH sensor-detected pH value, secondly enables the supply of purified water by opening the reusable water supplying valve with the water supplying valve closed and thirdly opens the final drain valve when a high-level signal is input from the high water level sensor.

### BRIEF DESCRIPTION OF THE DRAWING

FIG. 1 illustrates a perspective view showing an installation example of the food waste disposal system equipped with a BOD reduction system according to one embodiment of the present invention.

FIG. 2 illustrates a schematic diagram showing the configuration of the BOD reduction system according to one embodiment of the present invention.

FIG. 3 illustrates a plan view showing an optimal installation of the BOD reduction system according to one embodiment of the present invention when it has been actually installed.

FIG. 4 illustrates piping diagrams of the food waste disposal system and BOD reduction system according to one embodiment of the present invention.

### DETAILED DESCRIPTION OF THE PREFERRED EMBODIMENTS

The above-described objects, advantageous effects and features of the present invention will be apparent from the following description with reference to the accompanying drawings.

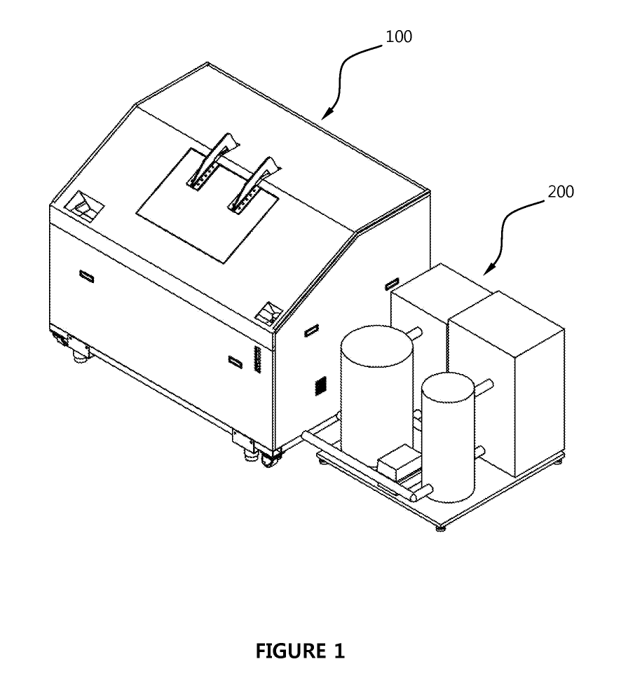

FIG. 1 illustrates a perspective view showing an installation of the food waste disposal system equipped with a BOD reduction system according to one embodiment of the present invention.

The food waste disposal system equipped with a BOD reduction system under this invention comprises a food waste disposal system unit 100 and a BOD reduction system 200 which works to ferment and decompose food residuals contained in sewage drained from the food waste disposal system unit 100.

The food waste disposal system unit 100 under this invention is the same as the food waste disposal system posted U.S. Pat. No. 7,735,761, U.S. Pat. No. 7,762,713 and U.S. application No. 13304516 by the same inventor of this application, so the detailed description thereof will be left out.

A connecting pipe 21a that carries the food wastewater discharged from the food waste disposal system 100 under this invention is connected to the inlet of the BOD reduction system 200, and pipe connections are made for water purified in the BOD reduction system 200 to be carried back to the inlet of food waste disposal system 100 and thus be reusable in the food waste disposal system 100.

The BOD reduction system 200 under this invention comprises four main parts: a concentrated-oxidizing tank 21, an aeration tank 22, an air pump 23 and a filter 24.

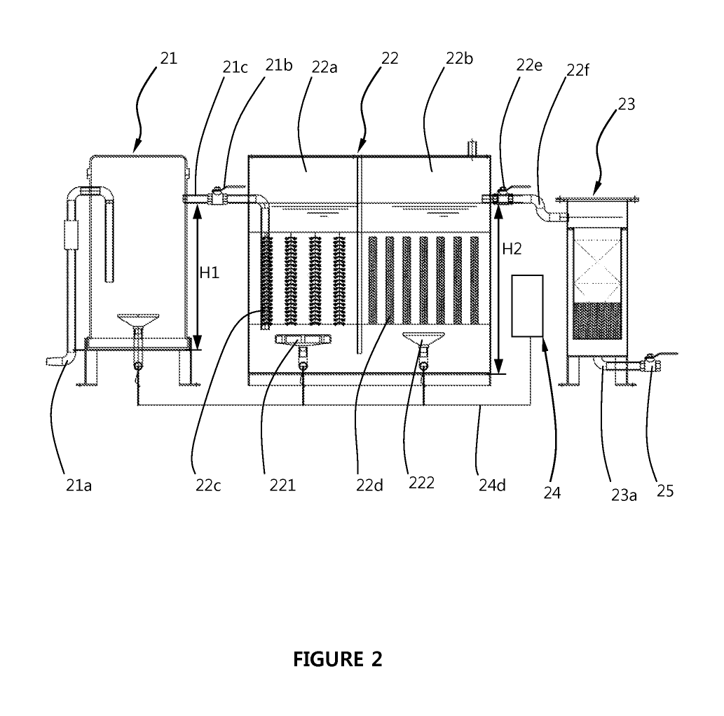

FIG. 2 illustrates a schematic diagram showing the configuration of the BOD reduction system according to one embodiment of the present invention.

The BOD reduction system 200 under this invention comprises the concentrated-oxidizing tank 21 which receives food wastewater containing food residuals discharged from the food waste disposal system 100 through the connecting pipe 21a. In this tank, the influent food wastewater is stored for several days and mixed with air supplied from the air pump 24, and then oxidized by aerobic bacteria. After the inflow of influent food wastewater into the concentrated-oxidizing tank 21, wastewater and nitrogen and phosphorus are removed from the wastewater and suspended solids and other residues are filtered out of it by fluidized media where microorganisms are attached and grow.

The influent food wastewater purified first in the concentrated-oxidizing tank 21 flows into the aeration tank 22 which comprises the first aeration chamber 22a and the second aeration chamber 22b. The first aeration chamber 22a receives the influent food wastewater from the concentrated-oxidizing tank above 21 via a connecting pipe 21c equipped with a valve 21b, and the received food wastewater goes through the first fermentation process inside the first aeration chamber 22a.

The first aeration chamber 22a is equipped with a plurality of fixed media 22c. If air is blown into the chamber through an air pipe 24a from the outer air pump, oxygen flows into the tank through the disc rubber diffuser 221 and such inflow of oxygen causes aeration.

The second aeration chamber 22b is equipped with a plurality of plate-type media 22d. If air blown into the chamber through the air pipe 24a from the outer air pump 24, oxygen flows into the tank through the membrane diffuser 222 and such inflow of oxygen leads to an aeration process.

The oxidizing aeration tank 22 contributes to efficient purification of influent food wastewater by allowing food residuals in the wastewater to be further decomposed while going through an oxidation process and allowing food residuals to be continuously filtered out by media (22c, 22d).

In the aeration tank 22, decomposed precipitates settle down to the bottom but can be later discharged through a maintenance process. The influent food wastewater purified in the aeration tank 22 is filtered by the filter 23 for the last time.

The filter 23 is equipped with gravel and activated carbon filter units, and food residuals are filtered out and purified to the end when water through the filter. It is recommended to replace the filter 23 every three months for effective filtering.

Once influent food wastewater has passed through all the treatment and filtration processes in the concentrated-oxidizing tank, aeration tank and filter as described above, its BOD will be reduced to about 1000 lower in values than that of food wastewater when discharged at first from the food waste disposal system 100.

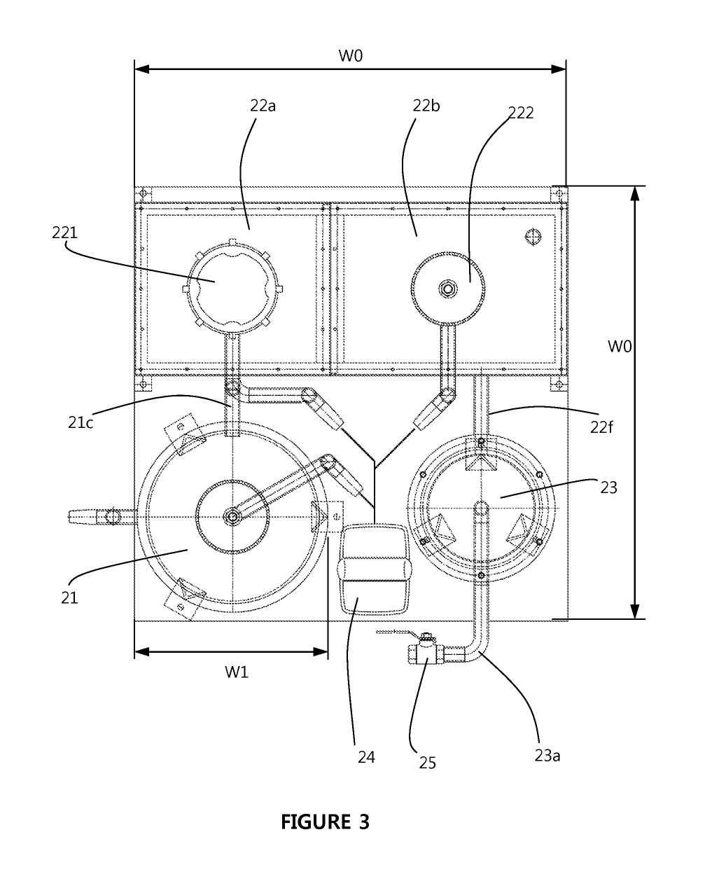

FIG. 3 illustrates a plan view showing an optimal installation of the BOD reduction system according to one embodiment of the present invention when it has been actually installed.

As illustrated, the BOD reduction system 200 under this invention has the concentrated-oxidizing tank 21 in front and the aeration tank 22 and provides space for filter installation 23 on the right side of the concentrated-oxidizing tank 21, the width (W1) of which is to be one half of the aeration tank's 22 (W0).

The filter 23 is set up in the space on the right of the concentrated-oxidizing tank 21, and the total width of the filter is not to be greater than the aeration tank's 22 width (W0). The air pump 24 is placed between the concentrated-oxidizing tank 21 and the aeration tank 23, and thus an overall square-shaped arrangement is made with side length equal to the aeration tank's 22 width (W0).

Like this, the BOD reduction system 200 under this invention is designed to minimize the size of the unit and thus installation space by placing the concentrated-oxidizing tank 21, the aeration tank 22, the filter 24 and the air pump 24 in proper positions.

As illustrated in FIG. 2, the concentrated-oxidizing tank 21, the aeration tank 22 and the filter 24 are connected to each other by connecting pipes (21c, 220, and they (21c, 22f remain adjusted to specific heights so that the next process can automatically start when the influent food wastewater reaches a certain level (H1 or H2).

For maintenance purposes, a manual valve 25 is mounted on the final drain 23d of the filter 23, and thus purified water can be selectively drained by opening or closing the manual valve 25.

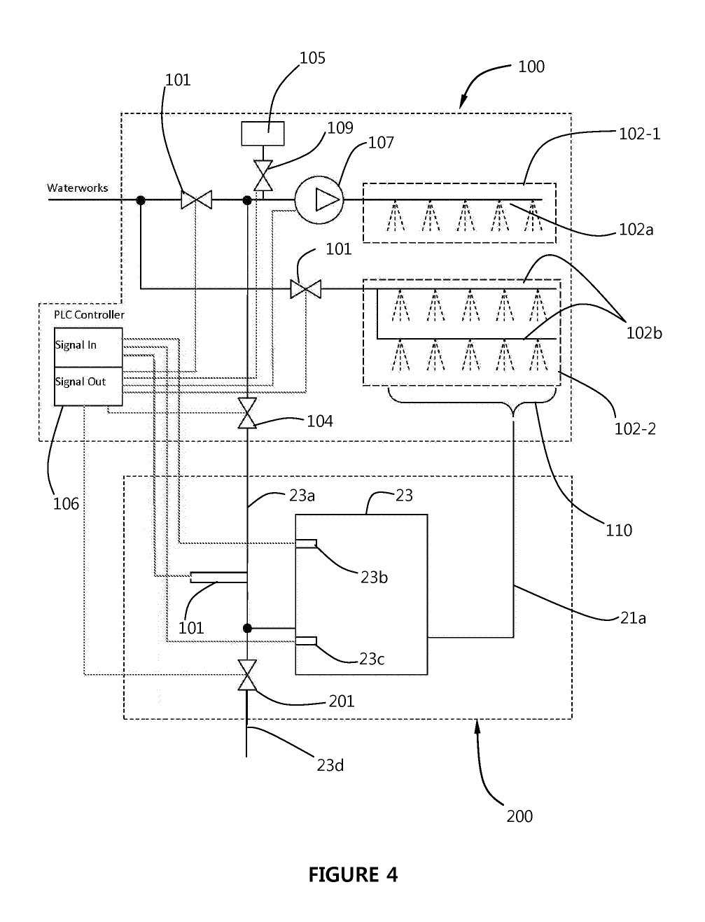

FIG. 4 illustrates piping diagrams of the food waste disposal system and BOD reduction system according to one embodiment of the present invention and a circuit diagram showing how individual valves and controllers are connected.

A piping diagram provides an explanation of how the water purified by the BOD reduction system 200 is reused in the food waste disposal system 100.

The food waste disposal system 100 under the present invention comprises a water supplying valve 101 which opens and closes the water supplied from waterworks; a water supplying pump 107 which pumps water supplied from the water supplying valve 101 into the mixing basin's 102-1 water supply nozzles 102a; a discharge valve 108 which is opened or closed by the PLC 106 for water supplied from waterworks to be drawn into a washing chamber's 102-2 discharging water supply nozzles 102b; a caustic soda tank valve 109 which opens and closes the feed for caustic soda stored in the caustic soda tank 105; a reusable water supplying valve 104 which is opened or closed by the PLC 106 for supply of water purified in the BOD reduction system's 200 filter 23; high and low water level sensors (23b and 23c) which work to detect the water levels of the BOD reduction system's 200 filter 23; a pH sensor 202 set up in a filter drain 23a of the filter 23 to measure acidity and basicity; a final drain valve 201 set up in a final drain 23d; and the PLC 106 which firstly controls the caustic soda tank valve 109 allowing caustic soda to be put in water pumped by the water supplying pump 107 based on a pH sensor-detected pH value, secondly enables the supply of the purified water by opening the reusable water supplying valve 104 with the water supplying valve 101 closed and thirdly opens the final drain valve 201 when a high-level signal is input from the high water level sensor 23b.

For the food waste disposal system 100, basically piping is designed in order for water to be supplied from a water supply line (waterworks) in a building. The water line of the food waste disposal system 100 is divided into two lines for the following functions: water supplying function operated by the water supplying valve 107 and the discharging function operated by the discharge valve 108. Both functions spray water through the spray nozzles (102a, 102b). The water supply function is performed through the water supplying pump 107 and the discharging function through the discharging valve 108. At this time, the original water pressure existing in the water supply line of the waterworks is used.

The filter drain 23a is connected to the water line between the water supply valve 101 and the water supply pump 107. A reusable water supplying valve 104 is installed between the water supply function line and the filter drain 23a of the BOD reduction system 200, which is opened by PLC 106. Therefore, the purified water in the BOD reduction system 200 is supplied to the food waste disposal system for reuse.

The purified water in the BOD reduction system 200 is recycled only for the water supplying function because the water should be pumped to maintain enough pressure to be sprayed through the nozzle. There is no pumping device in the discharging function line and all the purified water from the BOD reduction system 200 is sent to water supplying function.

Given below is an explanation of the operation of the food waste disposal system equipped with the BOD reduction system under this invention.

Once the food waste disposal system 100 is in operation mode, the water supplying valve 101 is opened and water is sprayed into the mixing basin 102-1. Then, a plurality of mixing blades rotates to mechanically agitate the food waste and the microorganism seeded inside of the mixing basin 102-1 starts to biologically decompose the food waste.

The residues that are generated while food waste is decomposed pass through a plurality of perforation formed at the bottom of the mixing basin 102-1 and then, collected in the washing chamber 102-2. The discharging valve 108 is opened to cleanse them out so that the food wastewater is discharged out to the drain 110 of the food waste disposal system 100.

In the process that food waste is decomposed, water flows out through the drain 110, in which the residues of the decomposed food waste are mixed. This food wastewater goes into the sewage system in a building, but in this case, the quality of water may not meet the standards regulated by each country. It is one of the biggest challenges to control BOD level, which is one of the most important standards for sewage water quality. In order to resolve this matter, the BOD reduction system 200 is connected to the drain 110 of the food waste disposal system 100 through the connecting pipe 21a. Once the food wastewater flows into the BOD reduction system 200, it goes through the concentrated-oxidizing process in the first concentrated-oxidizing tank 21, and it passes through the first aeration chamber 22a and the second aeration chamber 22b. In this process, most of solid and floating matters are decomposed. Finally, the sewage goes through the filter 23 and becomes purified.

On the upper and the lower part of the filter 23, high and low water level sensors (23b and 23c) are installed so the quantity of purified water is sensed. Once particular quantity of water is collected, the purified water is supplied through the water supplying cycle. To use the purified water in the food waste disposal system 100, the water supplying valve 101 remains closed and the reusable water supplying valve 104 opens instead.

The water purified in the BOD reduction system 200 is mainly used for the water supplying function so the quantity of water consumed from the waterworks by the food waste disposal system 100 can be remarkably reduced. In order to maintain the favorable condition inside the mixing basin 102-1 of the food waste disposal system 100, the water reused for about 10 cycles won't be used again and instead, it will be all discharged to sewage system in the building by the final drain valve 201.

So, the final drain valve 201 is open to discharge all the water in the filter 23 after 10 time use of recycled water. After all the water is discharged, new cycle starts from the initial process.

In case when the cycle frequency of discharging function is increased, the quantity of water flowing into the filter could be more than the quantity of water reused for the water supplying function and possibly causes overflow problem in the filter 23. In order to cope with this situation, the high water level sensor 23b is mounted in the tank of the filter 23. Therefore, once the quantity of water exceeds the height of the high water level sensor 23b, the final drain valve 201 immediately opens and discharges all the water collected in the filter 23 to prevent the overflow of purified water.

The pH sensor 202, which can measure acidity and basicity, is mounted on the filter drain 23a of the filter composing the BOD reduction system 200. When pH of the sensor is less than pH 3, small quantity of caustic soda powder is input from the caustic soda tank 105 mounted on the pipe of the rear end of the water supplying valve 101 of the food waste disposal system 100.

The conditions of the mixing basin 102-1 are likely to be acidified when food waste is decomposed by microorganisms and the food wastewater after the decomposition process also becomes acidified when drained out.

In actual case, the pH value of the food wastewater coming from the food waste disposal system 100 is always lower than pH 7. So, only the basic substance is necessary for neutralizing acidified food wastewater before going to be drained. In order to input caustic soda powder, the caustic soda tank 105 is installed on the pipe. Based on the pH value sensed by the pH probe sensor 202, it is possible to adjust acidity and basicity of the final food wastewater by adding caustic soda to the supplying water.

According to the present invention, the BOD level of the food wastewater from the food waste disposal system is improved as a BOD reduction system installed. Also, the pH sensor and caustic soda tank are installed to improve pH levels so that the food wastewater quality standard of each country can be satisfied. Further, the purified water is reusable in the food waste disposal system and accordingly the amount of water to be used in the food waste disposal system is significantly reduced. All this makes the equipment under this invention to be more environmentally friendly.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A Food waste disposal system including a BOD reduction system comprising:
a. a concentrated-oxidizing tank which receives a food wastewater containing food residuals discharged from said food waste disposal system through a connecting pipe and the influent food wastewater is stored for several days and mixed with air supplied from an air pump, and then oxidized by aerobic bacteria;
b. a aeration tank in which the influent food wastewater initially purified in said concentrated-oxidizing tank goes through the fermentation process;
c. a filter which contains different layers of sand, gravel, granule gravel, charcoal and glass wool;
d. an air pump which works to supply air to said concentrated-oxidizing tank and said aeration tank;
wherein said concentrated-oxidizing tank, said aeration tank and said filter are connected to each other by connecting pipes and the height of said connecting pipes remain adjusted so that the next process can automatically start when the influent food wastewater reaches a certain level, and
wherein a drain of said food waste disposal system is connected to a inlet of said BOD reduction system and purified water in said BOD reduction system is carried back to a inlet of said food waste disposal system so that purified water is reused in said food waste disposal system.

2. A Food waste disposal system including a BOD reduction system according to claim 1, wherein said aeration tank comprises a first aeration chamber and a second aeration chamber and said first aeration is equipped with a plurality of fixed media and a disc rubber diffuser to flow in oxygen from said air pump and said second aeration chamber is equipped with a plurality of plate-type media a membrane diffuser to flow in oxygen from said air pump.

3. A Food waste disposal system including a BOD reduction system according to claim 1, wherein said concentrated-oxidizing tank is located in front and said aeration tank in the back, providing space for said filter on the right side of said concentrated-oxidizing tank, the width of which is to be one half of said aeration tank's and said filter is set up in the space on the right of said concentrated-oxidizing tank, and the total width of said filter is not to be greater than said aeration tank's width so that said air pump is placed between said concentrated-oxidizing tank and said aeration tank, thus an overall square-shaped arrangement is made with side length equal to said concentrated-oxidizing tank's width.

4. A Food waste disposal system including a BOD reduction system according to claim 1, wherein, on the upper and the lower part of said filter, a high water level sensor and a low water level sensor are installed so the quantity of purified water is sensed by said low water level sensor and once particular quantity of water is collected, the water is reused to water supplying function cycle in said food waste disposal system.

5. A Food waste disposal system including a BOD reduction system according to claim 1, further comprising:
a. a water supplying valve which opens and closes the water supply from waterworks;
b. a water supplying pump which pumps water supplied from said water supplying valve into a mixing basin;
c. a discharge valve which is opened or closed by a Programmable Logic Controller (PLC) for water supplied from waterworks to be drawn into a washing chamber's discharging water supply nozzle;
d. a caustic soda tank valve which opens and closes the feed for caustic soda into a water line of said food waste disposal system;
e. a reusable water supplying valve which is opened or closed by said PLC for supply of purified water in said BOD reduction system's said filter;
f. a pH sensor set up in a filter drain to measure acidity and basicity;
g. a final drain valve set up in a final drain;
wherein said PLC firstly controls said caustic soda tank valve allowing caustic soda to be put in water pumped by said water supplying pump based on a pH sensor-detected pH value, secondly enables the reuse of purified water by opening said reusable water supplying valve with said water supplying valve closed and thirdly opens said final drain valve when a high-level signal is input from said high water level sensor.
